(19) United States
(12) Patent Application Publication
(10) Pub. No.: US 2007/0165029 A1
(43) Pub. Date: Jul. 19, 2007

(54) METHOD AND APPARATUS FOR GENERATING SHADOW BY USING AN ADAPTIVE SHADOW VOLUME ALGORITHM

(75) Inventors: Ruen-Rone Lee, Taipei (TW); Shao-Chen Peng, Taipei (TW)

Correspondence Address: WPAT, PC, 7225 BEVERLY ST., ANNANDALE, VA, 22003, US

(73) Assignee: VIA TECHNOLOGIES, INC., Taipei (TW)

(21) Appl. No.: 11/458,101

(22) Filed: Jul. 18, 2006

(30) Foreign Application Priority Data
Aug. 30, 2005 (TW) 094129727

(51) Int. Cl. G06T 15/50

(52) U.S. Cl. 345/426

(57) ABSTRACT

A method and apparatus for generating shadow by using an adaptive shadow volume algorithm are disclosed. By accumulating the number of Z pass and Z fail during shadow volume rendering, the performance can be improved by adaptively selecting the z pass algorithm or the z fail algorithm. Accordingly, one of the algorithms (z-pass or z-fail) with better performance is used as the shadow volume algorithm for next frame.

### BACKGROUND OF THE INVENTION

1. Field of the Invention

The present invention is generally related to a method and apparatus for generating shadow by shadow volume algorithms, and more particularly, a method and apparatus for generating shadow by adaptively using Z pass algorithm and Z fail algorithm.

2. Description of the Prior Art

In a three-dimensional graphics system, shadow rendering needs additionally techniques to process. That is, the pixels in the shadow need to be identified. These identified techniques include shadow volume, shadow mapping and so forth.

The method of shadow volume mainly defines a volume shaded by a shadow as a shadow volume to determine which part on a frame is positioned in the shadow volume. As shown in FIG. 1A, assuming that a light is radiated from a light source A and an obstacle B is provided to block in front of the light, the area that the light is shaded by the obstacle B is called a shadow volume S. The shadow volume S can be identified by a front face and a back face. When an object O on the frame is projected on a displaying plane G, it can be seen that only the part between positions D and E is within the shadow volume S and the rest is beyond the shadow volume S.

According to the above, as long as the shadow volume of the frame is defined, whether the pixels on the frame are positioned in the shadow volume or not can be determined. However, while projecting a three-dimensional image on a two-dimensional frame, the relationship of relative positions between objects in the three-dimensional image needs to be taken extra care because only the most front part of the image is displayed in the two-dimensional frame. Therefore, in the case of projecting a three-dimensional image on a two-dimensional plane, there is a need to raster which pixels and depths thereof are projected by the object. Because the three-dimensional object is sequentially rastered on the two-dimensional plane, the graphics system will record the current depth for each pixel. In order to describe clearly, the depth of the object relative to a projected pixel (on the rastered object) is referred to as “to-be-tested depth” while the depth displayed by the projected pixel (in the frame buffer) is referred to as “tested depth” (in a frame buffer). Thus, if the to-be-tested depth is smaller than the tested depth, the rastered object is in front of the current position displayed by the projected pixel and the projected pixel needs to be revised to display the rastered object and the tested depth with respect to the projected pixel needs to be replaced by the to-be-tested depth. Therefore, when the tested depth corresponding to a certain pixel is in the shadow volume, the pixel has to be rastered by the color of the shadow. The above-mentioned depth test can be a general Z test or a coarse Z test. The general Z test is performed by one pixel as a unit while the coarse Z test is performed simultaneously by a block of pixels. In the coarse Z test, there are a plurality of to-be-tested depths and tested depths. Thus, when the smallest to-be-tested depth is larger than the largest tested depth, the result of the coarse Z test is all Z fail. On the other hand, when the largest to-be-tested depth is smaller than the smallest tested depth, the result of the coarse Z test is all Z pass. If the result of the coarse Z test is not either all Z fail or all Z pass, the result of the coarse Z test is undetermined. In the undermined condition, a general Z test needs to be performed.

Generally, the process of projecting the three-dimensional object on the two-dimensional frame comprises firstly defining a plurality of polygons to represent the three-dimensional object and then using the polygons to perform the Z test. In the same manner, each shadow volume is represented by a plurality of polygons including front-face polygons representing the front face and back-face polygons representing the back face. Finally, determing whether the to-be-tested depths are positioned in the shadow space between the front-face polygons and the back-face polygons or not.

To generate shadow by ray tracing technique is very time-consuming, especially in the situation of providing multiple obstacles and multiple light sources. Thus, an effective method is required to generate shadow. The stencil shadow volume method updates a stencil buffer to perform a simple I/O calculation to simplify such operation. This method determines pixels in the shadow by performing the Z test of the front-face polygons and the back-face polygons in the shadow volume. For example, the value in the stencil buffer depends on the Z test of the front-face polygon and the back-face polygon to be increased or decreased. If the final stencil value is zero, the pixel is not in the shadow.

In the Z test of the shadow volume, the case of the tested depth larger than the to-be-tested depth is referred to as Z pass. On the contrary, it is referred to as Z fail. The rule of updating the stencil buffer includes two major algorithms, the Z pass algorithm and the Z fail algorithm. The Z pass algorithm updates the stencil buffer only on Z pass. The value in the stencil buffer is increased if Z pass hits the front-face polygon and decreased if Z pass hits the back-face polygon. On the other hand, the Z fail algorithm updates the stencil buffer only on Z fail. The value in the stencil buffer is decreased if Z fail hits the front-face polygon and increased if Z fail hits the back-face polygon.

FIGS. 1B and 1C show the schematic diagrams of the Z pass algorithm and the Z fail algorithm. A light source A forms three shadow volumes because obstacles B, C, and D are provided. Objects E and F are located inside and outside of the shadow volume respectively. In the Z pass algorithm, the stencil value with respect to a point E′ is +1+1=2 and thus the point E′ is inside the shadow volume, while the stencil value with respect to a point F′ is +1+1−1−1=0 and thus the point F′ is outside the shadow volume. The updated times of the stencil values for the points E′ and F′ are totally 6 times. On the contrary, in the Z fail algorithm, the stencil value with respect to the point E′ is +1−1+1+1=2 and thus the point E′ is inside the shadow volume, while the stencil value with respect to the point F′ is 0 and thus the point F′ is outside the shadow volume. The updated times of the stencil values for the points E′ and F′ are totally 4 times. Obviously, the Z fail algorithm is more feasible for the above viewing angle. For the same viewing angle, the result is the same by different algorithm but the amount of the required calculations is different. Moreover, the view depends on different viewing angle. Thus, the feasible algorithm may be different for a different viewing angle. For example, by viewing from the point I in FIG. 1D, the point E′ and F′ seen in FIG. 1C but are unseen in FIG. 1D, it becomes point e′ and f′ are seen in FIG. 1D. The updated times in the Z fail algorithm is becoming 7, 3 times for the point e′ and 4 times for the point f′. The updated times in the Z pass algorithm is becoming 3, 3 times for the point e′ and 0 times for the point f′. Accordingly, the Z pass algorithm is more feasible.

FIG. 1E shows an example illustrating the relationship of the updated times in the stencil values by Z pass and Z fail in several consecutive frames. Some has more updated times on Z pass while some has more updating times on Z fail. Thus, if only one algorithm is chosen for all of the frames, the algorithm is not feasible for quite a few of frames. Therefore, a novel method is required to reduce the updated times for the stencil value.

It can be seen from the above examples, either the Z pass algorithm or the Z fail algorithm results in the same conclusion. However, the amount of calculations depends on the algorithm and the viewing angle. In the practical application, generally either the Z pass algorithm or the Z fail algorithm is chosen. However, the amount of calculations strongly depends on the selected algorithm as well as the viewing angle and can become huge for some conditions. Therefore, the cost of calculations and the bandwidth for updating the stencil buffer can become very large because of some viewing angles. Therefore a method for perform calculations by using a feasible Z test is required.

### SUMMARY OF THE INVENTION

One object of the present invention is to collect statistics of the number of the Z pass and the number of the Z fail in the Z test and then to determine a shadow volume algorithm for next frame according to the smaller one between the two statistic values.

Another object of the present invention is to collect statistics of the number of all Z pass and the number of all Z fail in the Z test and then to determine a shadow volume algorithm for next frame according to the smaller one between the two statistic values.

According to the described objects, the invention provides a method and apparatus for generating shadow by shadow volume algorithm. When rendering the shadow volume of a frame, the performance of the Z pass algorithm and the Z fail algorithm for the frame is known by collecting statistics of the numbers on the Z pass and the Z fail respectively. From the result, a more feasible one is selected as the shadow volume algorithm for next frame.

### BRIEF DESCRIPTION OF THE DRAWINGS

FIGS. 1A to 1E are schematic diagrams illustrating the prior art;

FIG. 2 is a schematic flow chart in an embodiment of the present invention;

FIG. 3 is a schematic flow chart in another embodiment of the present invention;

FIG. 4 is a schematic functional block diagram in another embodiment of the present invention; and,

FIG. 5 is a comparison diagram illustrating the advantages and disadvantages of the present invention compared to the prior art shown in FIG. 1E.

### DESCRIPTION OF THE PREFERRED EMBODIMENTS

What is probed into the invention is a method and apparatus for generating shadow by using adaptive shadow volume algorithm. Detail descriptions of the structures and processes will be provided in the following in order to make the invention thoroughly understood. Obviously, the application of the invention is not confined to specific details familiar to those who are skilled in the art of the lighting devices. On the other hand, the common processes and compositions that are known to everyone are not described in details to avoid unnecessary limits of the invention. Some preferred embodiments of the present invention will now be described in greater detail in the following. However, it should be recognized that the present invention can be practiced in a wide range of other embodiments besides those explicitly described, that is, this invention can also be applied extensively to other embodiments, and the scope of the present invention is expressly not limited except as specified in the accompanying claims.

Shadow volume algorithm includes Z pass algorithm and Z fail algorithm. In a plurality of consecutive frames, the Z pass algorithm may have better performance to determine the pixels inside the shadow volume in some frames, while in some other frames, the Z fail algorithm may have better performance. Therefore, if only one shadow volume algorithm is used to determine pixels in the shadow volume, the performance may become worse.

In the consecutive frames, one or more scenes may be included. The frame of the same scene presents almost the same objects, especially for background. Although the scene is the same, the objects and the related shadows will be different due to different viewing angles. Even so, the differences between neighboring frames in the same scene are little. Thus, if the Z pass algorithm is feasible for a frame, it may also more feasible for next frame than the Z fail algorithm, and vice versa. Hereafter, the front-face polygons and back-face polygons of a shadow volume are both referred to as “shadow volume polygons”.

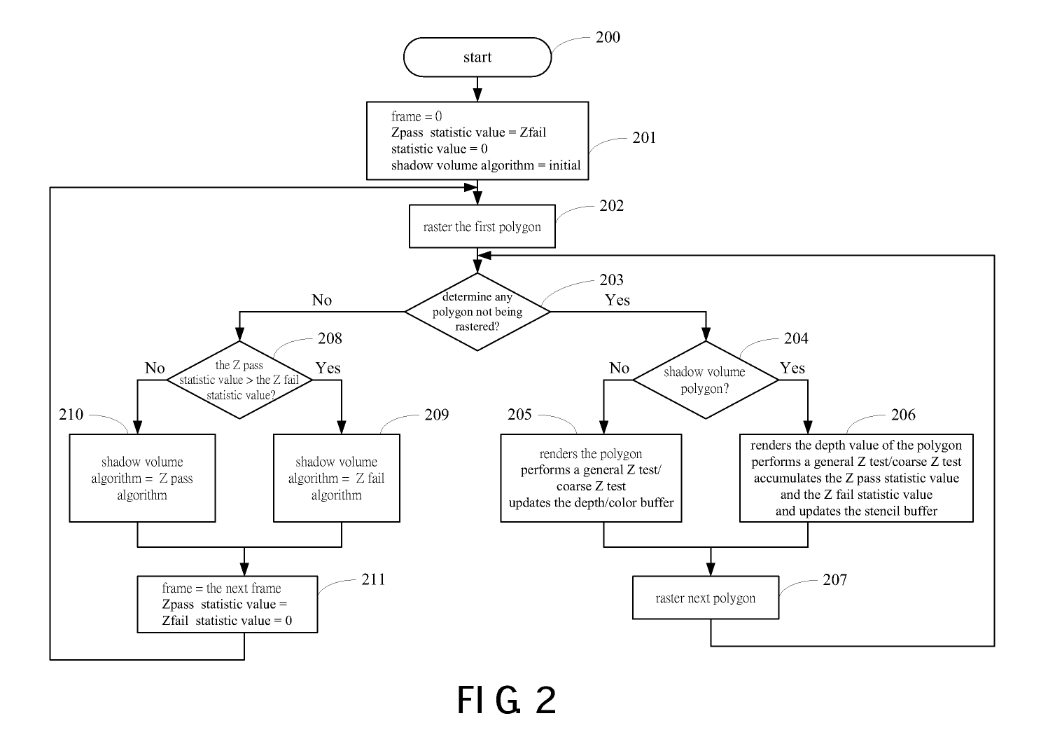

FIG. 2 is a schematic flow chart of an embodiment according to the present invention. According to the prior art, polygons include polygons of general image objects and shadow volume objects. Usually, they are rastered at different stages. At first, the polygons of general image objects are rastered. Then, the shadow volume polygons are rastered. The flow starts from step 200. Step 201 initializes a Z pass statistic value, a Z fail statistic value and a predetermined shadow volume algorithm which is selected from either the Z pass or the Z fail algorithm. Step 202 starts to raster the first polygon and step 203 determines if there is any polygon not being rastered. If there is polygon not being rastered in step 203, step 204 determines if the polygon is the shadow volume polygon. If the polygon is not the shadow volume polygon, step 205 renders the polygon, performs a general Z test/coarse Z test, and updates the depth/color buffer. Then, step 207 starts to raster next polygon. On the other hand, if the polygon is the shadow volume polygon, step 206 renders the depth value of the polygon, performs a general Z test/coarse Z test, accumulates the Z pass statistic value and the Z fail statistic value, and updates the stencil buffer. On the other hand, if polygons are all rastered in step 203, step 208 determines if the Z pass statistic value is larger than the Z fail statistic value. If the Z pass statistic value is larger than the Z fail statistic value, step 209 determines the Z fail algorithm as the shadow volume algorithm for next frame. If the Z pass statistic value equals to or smaller than the Z fail statistic value, step 210 determines the Z pass algorithm as the shadow volume algorithm for next frame. Then, whether in step 209 or step 210, they would go to step 211 to initializes the parameters for next frame. In the step 211, the rastered frame is assigned as the next frame and the Z pass statistic value and the Z fail statistic value are initialized, such as set to be zeros.

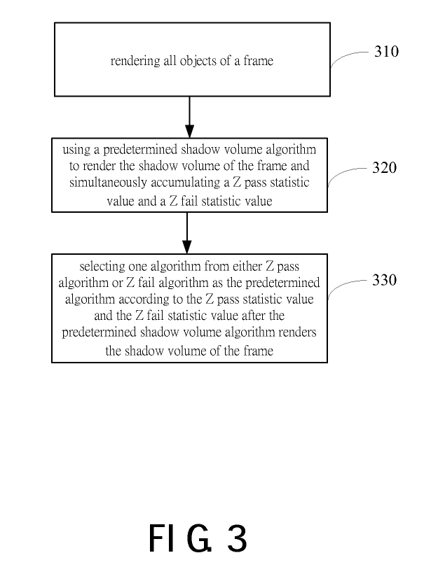

Referring to FIG. 3, which is another embodiment of the invention discloses a method for generating shadow by using adaptive shadow volume algorithm. At first, step 310 renders all objects of a frame in which every object is represented by a plurality of polygons and the frame is rendered by a plurality of pixels. These pixels are stored in the frame buffer. Then, step 320 uses a predetermined shadow volume algorithm to render the shadow volume of the frame and simultaneously accumulates the Z pass statistic value and the Z fail statistic value. Finally, step 330 selects one algorithm from either Z pass algorithm or Z fail algorithm as the predetermined algorithm according to the Z pass statistic value and the Z fail statistic value after the predetermined shadow volume algorithm renders the shadow volume of the frame. Therefore, steps 310 and 320 are repeated for next frame according to the shadow volume algorithm selected in step 330 to render the shadow volume.

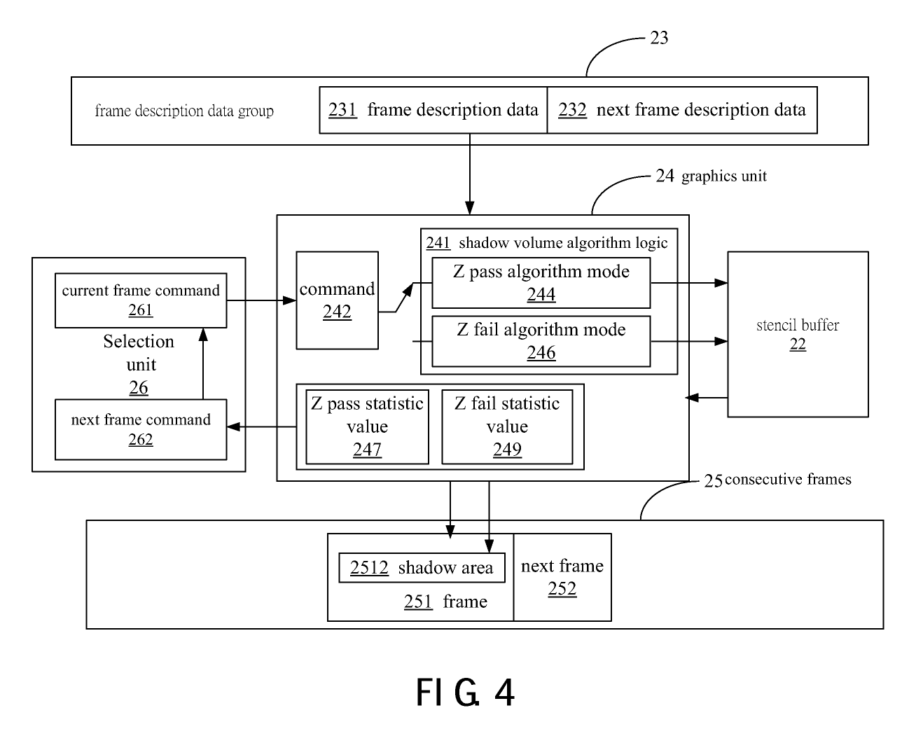

As shown in FIG. 4, which is another embodiment of the invention discloses an apparatus with adaptive shadow volume algorithm, comprising a stencil buffer 22, a graphics unit 24, and a selection unit 26. As shown in step 310, the graphics unit 24 renders all pixels of a frame 251 and the stencil buffer 22 stores the stencil value with respect to each pixel. The graphics unit 24 renders the frame 251 according to a frame description data 231. The frame description data 231 may be any frame description data in the frame description data group 23. The frame 251 may be any frame in the consecutive frames 25. The next frame after the frame 251 is referred to as “next frame 252”. The next frame 252 is rendered according to the next frame description data 232 after the frame 251 is rendered by the graphics unit 24. On the other hand, as shown in step 320, according to a command 242, the graphics unit 24 selects either the Z pass algorithm mode 244 or the Z fail algorithm mode 246 from the shadow volume algorithm logic 241 to update the stencil buffer 22. The graphics unit 24 updates the stencil value in the stencil buffer 22 by the shadow volume algorithm logic 241 so as to identify a shadow area 2512 corresponding to a viewing direction and simultaneously gathers statistics of the Z pass statistic value 247 and the Z fail statistic value 249. A command 242 with respect to the next frame 252 is generated by the selection unit 26 according to the Z pass statistic value 247 and the Z fail statistic value 249, as shown in step 330.

When the Z pass algorithm mode 244 is selected, the shadow volume algorithm logic 241 uses the Z pass algorithm to determine the shadow area 2512. On the contrary, when the Z fail algorithm mode 246 is selected, the shadow volume algorithm logic 241 uses the Z fail algorithm to determine the shadow area 2512. The shadow area 2512 is a set of pixels inside the shadow volume in the frame 251. The stencil value in the stencil buffer 22 with respect to the shadow area 2512 is not equal to zero. All of the pixels in the shadow area 2512 are rendered by the graphics unit 24 to generate shadow.

In addition, the graphics unit 24 uses the Z test to update pixel rendering for the frame 251. The Z pass statistic value 247 and the Z fail statistic value 249 are generated during the Z test of shadow volume rendering.

The selection unit 26 generates a next frame command 262 according to the Z pass statistic value 247 and the Z fail statistic value 249. The selection unit 26 selects the shadow volume algorithm mode corresponding to the smaller value between the Z pass statistic value 247 and the Z fail statistic value 249. For example, when the graphics unit 24 renders the next frame 252, the selection unit 26 selects the next frame command 262 as the current frame command 261 and then sends to the graphics unit 24 as the command 242. Besides, the selection unit 26 can be software or hardware, such as a logic circuit or software selected from a group consisting of driver or software AP.

As shown in FIG. 2, the result of the coarse Z test can be all Z pass, all Z fail, or undetermined. For the Z test, the steps 205 and 206 or the step 320 can use only the coarse Z test, only the general Z test, or use the coarse Z test first and then the general Z test if undetermined in the coarse Z test.

The step of rendering all objects of the frame includes recording and updating the Z value with respect to each pixel. Rendering the shadow volumes of the frame include updating the stencil value with respect to each pixel. These stencil values identify the pixels positioned in the shadow volumes of the frame. The stencil values and Z values are stored in the stencil buffer and the Z value buffer, respectively. Or, they can be all stored in a buffer. Besides, rendering the shadow volume can include performing a Z test for the Z values with respect to the plurality of pixels by a plurality of shadow volume polygons so as to update the stencil values with respect to the plurality of pixels according to the result of the Z test.

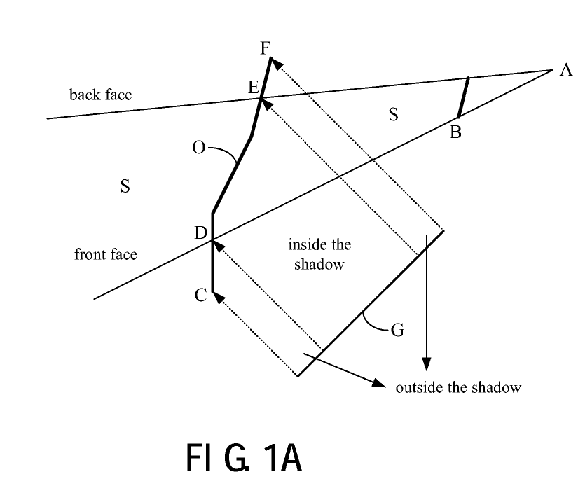

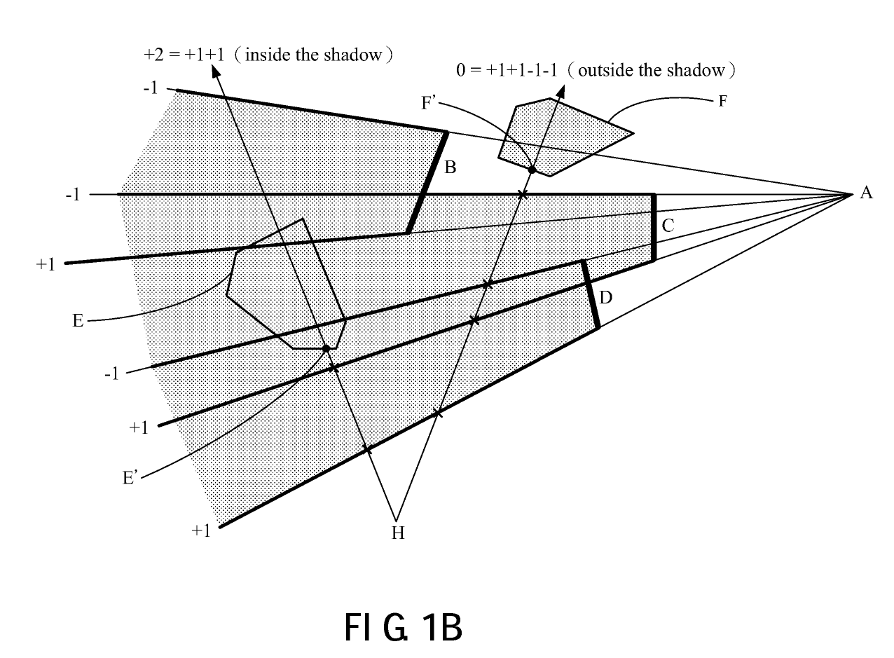

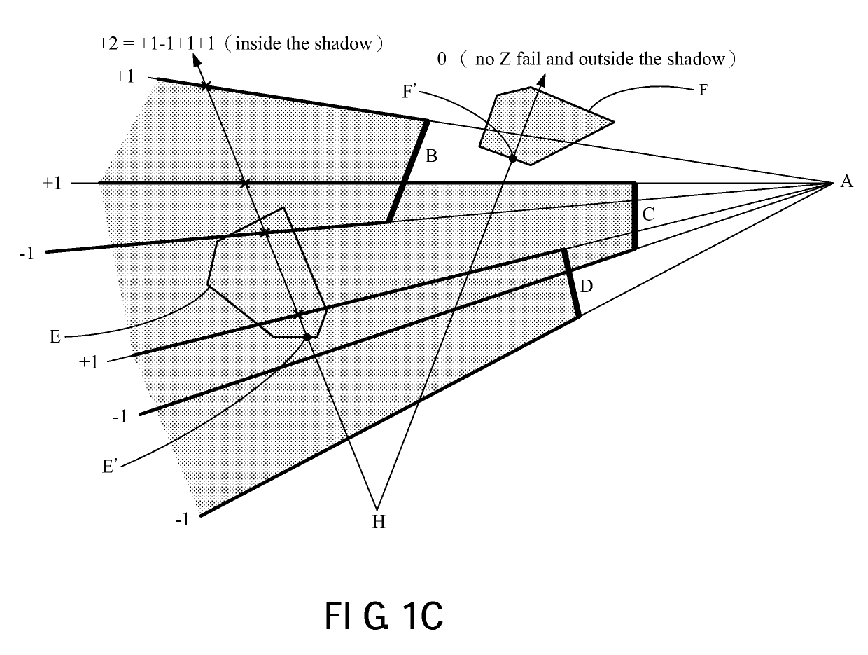

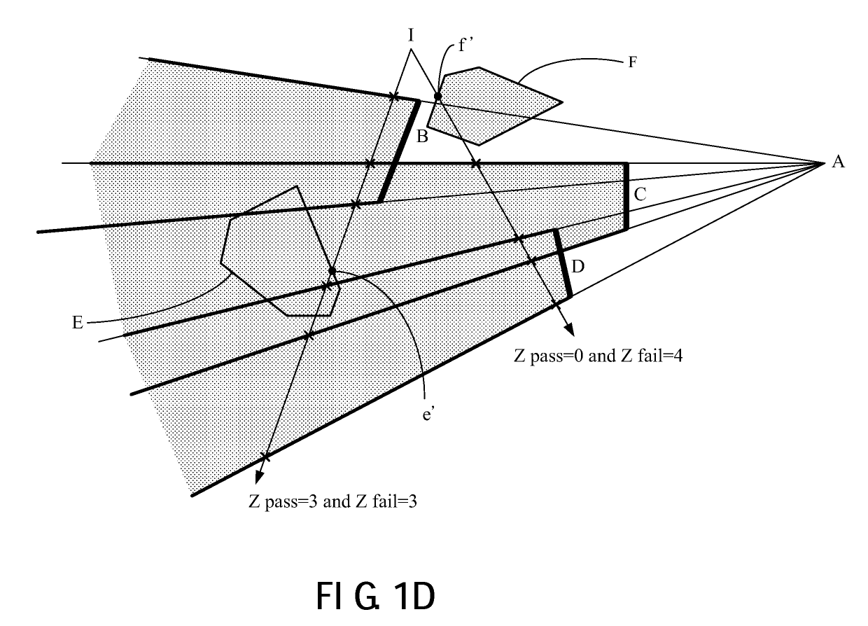

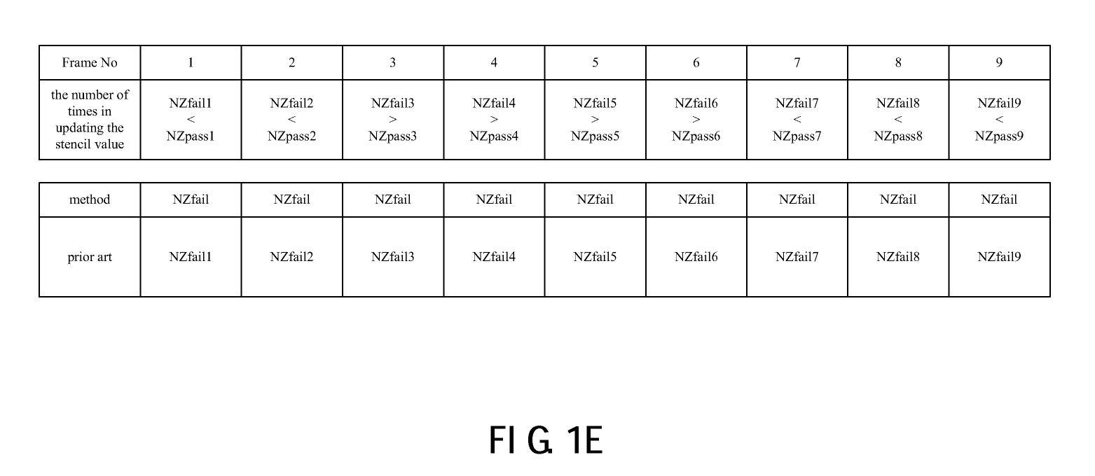

On the other hand, as shown in FIG. 1B, there are two types of polygons, shadow volume polygon and general object polygon (E, F). When a shadow volume polygon is rendered, the amount of pixels in front of the general object polygon is accumulated as the Z pass statistic value. Therefore, after every shadow volume polygon is rendered, the Z pass statistic value adds up the amount of pixels on Z pass for every shadow volume polygon. In the same manner, the Z fail statistic value adds up the amount of pixels on Z fail for every shadow volume polygon. Moreover, the Z pass algorithm updates the stencil value with respect to each pixel on Z pass for every shadow volume polygon while the Z fail algorithm updates the stencil value with respect to each pixel on Z fail for every shadow volume polygon

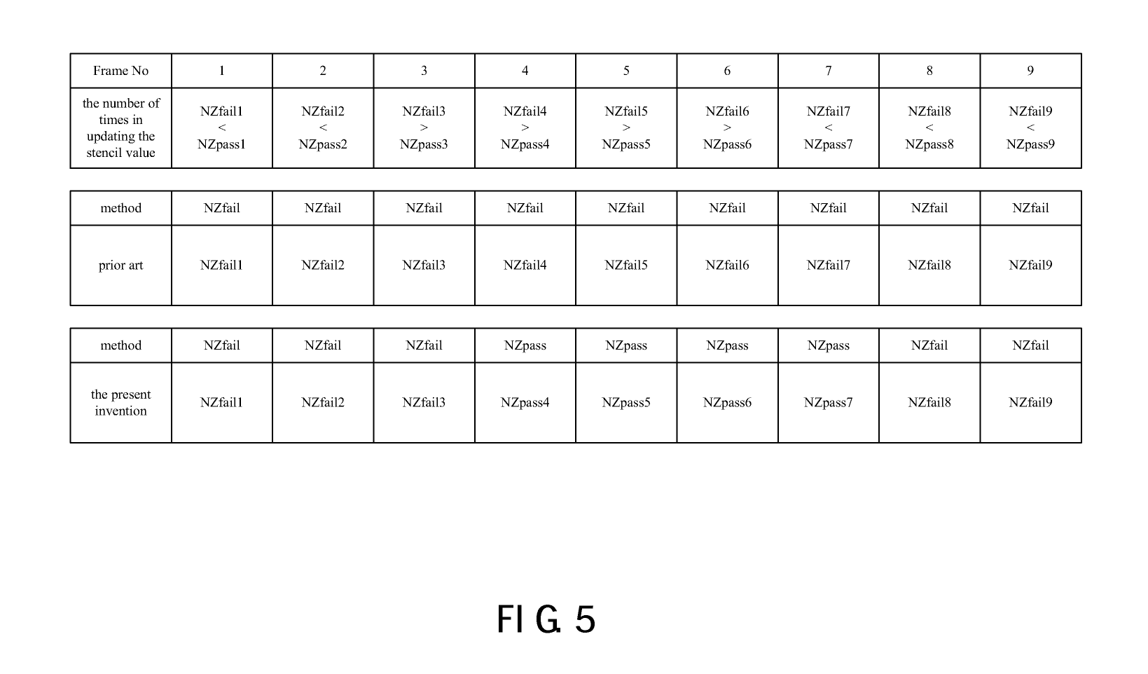

From FIGS. 1D and 5, the shadow volume algorithm according to the present invention is feasible for more frames than that according to the prior art. Obviously, the invention can adaptively select the feasible algorithm according to the content of consecutive frames so as to reduce the number of times in accessing the stencil buffer. Furthermore, for step 330 and in the selection device, the predetermined shadow volume algorithm is reset only when the difference of the Z fail statistic value and the Z pass statistic value is greater than a threshold number so as to reduce the amount of changing the shadow volume algorithm.

Obviously many modifications and variations are possible in light of the above teachings. It is therefore to be understood that within the scope of the appended claims the present invention can be practiced otherwise than as specifically described herein. Although specific embodiments have been illustrated and described herein, it is obvious to those who are skilled in the art that many modifications of the present invention may be made without departing from what is intended to be limited solely by the appended claims.

What is claimed is:

1. An apparatus for generating shadow by using an adaptive shadow volume algorithm, comprising:
a graphics unit using a plurality of pixels for rendering a frame wherein said graphics unit includes accumulation of the number of Z pass and the number of Z fail by a predetermined shadow volume algorithm to have a Z fail statistic value and a Z pass statistic value while rendering the shadow volume of said frame; and,
a selection unit selecting one algorithm from either the Z pass or the Z fail algorithm according to the Z pass statistic value and the Z fail statistic value after said graphics unit renders said frame by the predetermined shadow volume algorithm.

2. The apparatus for generating shadow by using an adaptive shadow volume algorithm according to claim 1, wherein said selection unit is software selected from a group consisting of driver and software AP.

3. The apparatus for generating shadow by using an adaptive shadow volume algorithm according to claim 1, wherein said graphics unit records and updates the Z value and the stencil value with respect to each pixel, in which the stencil value identifies the pixel positioned in the shadow volume of said frame.

4. The apparatus for generating shadow by using an adaptive shadow volume algorithm according to claim 3, wherein said graphics unit rendering the shadow volume includes performing a Z test for the Z values with respect to the plurality of pixels by a plurality of shadow volume polygons, said shadow volume polygons representing shadow volume.

5. The apparatus for generating shadow by using an adaptive shadow volume algorithm according to claim 4, wherein the Z test includes a general Z test which is performing one pixel by one pixel, and a coarse Z test which is performing by a block of pixels.

6. The apparatus for generating shadow by using an adaptive shadow volume algorithm according to claim 5, wherein the result of the coarse Z test for the whole block of said pixels is selected from a group consisting of all Z pass, all Z fail, and undetermined.

7. The apparatus for generating shadow by using an adaptive shadow volume algorithm according to claim 6, wherein said pixels in the block need undergoing the general Z test if the result of the coarse Z test is undetermined.

8. The apparatus for generating shadow by using an adaptive shadow volume algorithm according to claim 3, wherein said graphics unit accumulates the amount of pixels on Z pass for every shadow volume polygon to have a Z pass statistic value and also accumulates the amount of pixels on Z fail for every shadow volume polygon to have a Z fail statistic value in the Z test.

9. The apparatus for generating shadow by using an adaptive shadow volume algorithm according to claim 3, wherein the Z pass algorithm means the stencil value with respect to the pixel on Z pass for each shadow volume polygon is updated and the stencil value with respect to the pixel on Z fail for each shadow volume polygon is also updated.

10. The apparatus for generating shadow by using an adaptive shadow volume algorithm according to claim 1, wherein said selection unit selects the Z fail algorithm as the predetermined shadow volume algorithm if the Z pass statistic value is greater than the Z fail statistic value, and selects the Z pass algorithm as the predetermined shadow volume algorithm if the Z pass statistic value is smaller than or equal to the Z fail statistic value.

11. A method for generating shadow by using an adaptive shadow volume algorithm, comprising:
rendering all objects of a frame wherein each object is represented by a plurality of polygons and said frame is rendered by a plurality of pixels;
using a predetermined shadow volume algorithm to render the shadow volumes of said frame and simultaneously accumulate a Z pass statistic value and a Z fail statistic value; and,
selecting one algorithm from either Z pass algorithm or Z fail algorithm as the predetermined algorithm according to the Z pass statistic value and the Z fail statistic value after the predetermined shadow volume algorithm renders the shadow volume of said frame.

12. The method for generating shadow by using an adaptive shadow volume algorithm according to claim 11, wherein the step of rendering all objects of a frame includes recording and updating the Z value with respect to each pixel.

13. The method for generating shadow by using an adaptive shadow volume algorithm according to claim 12, wherein the step of using a predetermined shadow volume algorithm to render the shadow volume of said frame includes updating the stencil value with respect to each pixel, wherein the stencil value is used to identify the pixel in the shadow volume of said frame.

14. The method for generating shadow by using an adaptive shadow volume algorithm according to claim 12, wherein rendering the shadow volume includes performing a Z test for the Z values with respect to the plurality of pixels by a plurality of shadow volume polygons so as to update the stencil value with respect to the plurality of pixels.

15. The method for generating shadow by using an adaptive shadow volume algorithm according to claim 14, wherein the Z test includes a general Z test which is performing one pixel by one pixel, and a coarse Z test which is performing by a block of pixels.

16. The method for generating shadow by using an adaptive shadow volume algorithm according to claim 15, wherein the result of the coarse Z test for the whole block of said pixels is selected from a group consisting of all Z pass, all Z fail, and undetermined.

17. The method for generating shadow by using an adaptive shadow volume algorithm according to claim 16, wherein said pixels in the block need undergoing the general Z test if the result of the coarse Z test is undetermined.

18. The method for generating shadow by using an adaptive shadow volume algorithm according to claim 13, further comprising accumulating the amount of pixels on Z pass for every shadow volume polygon to have a Z pass statistic value and also accumulating the amount of pixels on Z fail for every shadow volume polygon to have a Z fail statistic value in the Z test.

19. The method for generating shadow by using an adaptive shadow volume algorithm according to claim 13, wherein the Z pass algorithm means the stencil value with respect to the pixel on Z pass for every shadow volume polygon is updated and the stencil value with respect to the pixel on Z fail for every shadow volume polygon is updated when the Z fail algorithm is used.
